(19) United States
(12) Patent Application Publication
(10) Pub. No.: US 2017/0344746 A1
(43) Pub. Date: Nov. 30, 2017

(54) UTILIZING LIKELY INVARIANTS FOR RUNTIME PROTECTION OF WEB SERVICES

(71) Applicant: INTERNATIONAL BUSINESS MACHINES CORPORATION, Armonk, NY (US)

(72) Inventor: Omer Tripp, Bronx, NY (US)

(21) Appl. No.: 15/164,116

(22) Filed: May 25, 2016

(51) Int. Cl. G06F 21/57; G06F 11/36

(52) U.S. Cl. CPC G06F 21/577; G06F 11/3668

(57) ABSTRACT

An exemplary method for use with an application includes: testing the application with a set of security payloads to produce a set of execution traces, wherein testing the application with a given one of the set of security payloads produces a corresponding one of the set of execution traces; determining a set of candidate points comprising at least one candidate point for each of the set of security payloads, wherein a candidate point for the given one of the set of security payloads is determined based on the corresponding one of the set of execution traces; inferring a set of trust boundaries based on the determined set of candidate points; computing one or more possible transition points across the inferred set of trust boundaries; and instrumenting the application with a security defense at each of the computed possible transition points across the inferred set of trust boundaries.

### BACKGROUND OF THE INVENTION

The present invention relates to the electrical, electronic and computer arts, and, more particularly, to application security.

Perfect enforcement of a security specification—e.g. to avoid all possible instances of an injection vulnerability like SQL injection—is known to be a hard problem. This is true in general, and especially when the person responsible for implementing the security defenses is a standard software engineer without any special background in application security.

This problematic situation is the reason for many reports of severe security attacks against websites owned by banks, corporates and governments. In response, a variety of testing and analysis tools have been developed to detect (potential) security vulnerabilities. These include algorithms for static security verification, such as IBM® Security AppScan® Standard, as well as black-box and glass-box security testing products, such as IBM® Security AppScan® Source, both commercially available from the assignee of the present application, International Business Machines Corp. (IBM® and AppScan® are both registered trademarks of International Business Machines Corp.)

While automated tools assist the developer in discovering potential security problems, the responsibility for fixing these problems ultimately remains in the hands of the developer. This means that if the security fix the developer has applied is wrong, or partial, then the application is still released in a vulnerable state.

Another related problem is that the quality of the analysis performed by the automated algorithm critically depends on how comprehensive and accurate the algorithm's configuration is. One example is the need by the user to input all sanitizer and validator methods appearing in the application's scope when using tools such as IBM® Security AppScan® Source. If the user inputs a wrong or broken defense, then this can result in false negatives. If, on the other hand, the user forgets to include a correct defense, then false positives are likely.

### BRIEF SUMMARY

An exemplary method for use with an application comprises: testing the application with a set of security payloads to produce a set of execution traces, wherein testing the application with a given one of the set of security payloads produces a corresponding one of the set of execution traces; determining a set of candidate points comprising at least one candidate point for each of the set of security payloads, wherein a candidate point for the given one of the set of security payloads is determined based on the corresponding one of the set of execution traces; inferring a set of trust boundaries based on the determined set of candidate points; computing one or more possible transition points across the inferred set of trust boundaries; and instrumenting the application with a security defense at each of the computed possible transition points across the inferred set of trust boundaries.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

These and other features and advantages of the present invention will become apparent from the following detailed description of illustrative embodiments thereof, which is to be read in connection with the accompanying drawings.

### BRIEF DESCRIPTION OF THE SEVERAL VIEWS OF THE DRAWINGS

The following drawings are presented by way of example only and without limitation, wherein like reference numerals (when used) indicate corresponding elements throughout the several views.

FIG. 1 is a flowchart showing an exemplary algorithm according to an illustrative embodiment of the present invention; and

FIG. 2 depicts a computer system that may be useful in implementing one or more aspects and/or elements of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

It is to be appreciated that the invention is not limited to the specific apparatus and/or methods illustratively shown and described herein. Moreover, it will become apparent to those skilled in the art given the teachings herein that numerous modifications can be made to the embodiments shown that are within the scope of the claimed invention. Thus, no limitations with respect to the embodiments shown and described herein are intended or should be inferred.

Principles of the present invention have use in connection with application security, including but not limited to automatic protection of web applications and web services. One or more illustrative embodiments of the present invention are particularly suitable for use with runtime application self-protection (RASP) in which a runtime system ensures the safety of the application running on top of it. For example, a compiler or runtime system may synthesize security checks into the code of the subject application to protect it against malicious users. This runtime instrumentation of the subject application (e.g., runtime checks) can be a source of significant overhead.

Thus, one or more illustrative embodiments of the present invention provide techniques for specializing, and optimizing, the behavior of a runtime system with respect to RASP, such as basing specialization on profiling traces. One or more illustrative embodiments constrain the overhead of runtime checks by monitoring the security-relevant behavior of the subject application over a collection of representative execution traces, and tailoring the scope and granularity of security checks accordingly, such that checks may be coarsened when appropriate.

One or more illustrative embodiments (1) infer the trust boundaries of the application automatically based on inspection of a finite number of execution traces (e.g. resulting from testing); and (2) automatically enforce security defenses on every transition into trusted areas. The user need not provide a specification, which is instead inferred automatically by exemplary algorithms. The system is also robust against user mistakes in the implementation of security defenses, compensating for the missing defense logic automatically. Thus, in illustrative embodiments thereof, aspects of the present invention advantageously overcome one or more inherent limitations of existing analysis and testing approaches.

One or more illustrative embodiments therefore provide an automatic protection mechanism which automatically instruments an application based on a computed trust boundary from a set of static analysis traces. Instrumentation of the code and dynamic execution thereof is used to compute a trust boundary that needs to be protected. The trust boundary is computed based on a given set of security traces that have a sanitizer or validator on them. Looping through the traces and identifying the sanitizers/validators creates the trust boundary that the program needs to protect. Then, using this information, every possible transition point into the trust boundary is automatically instrumented in a migration from “partial correctness” to “full correctness.”

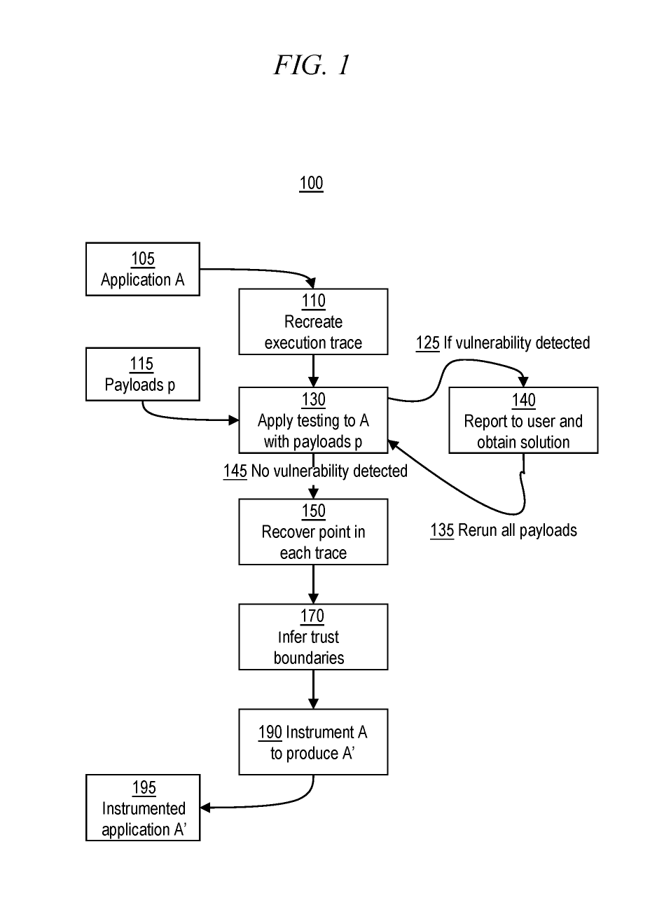

FIG. 1 is a flowchart showing an exemplary algorithm 100 according to an illustrative embodiment of the present invention. Algorithm 100 takes as inputs application A 105 and security payloads 115. Security payloads 115 are denoted pi . . . pn and may, for example, reflect common attack instances. Algorithm 100 produces an output 195 which is A′, an instrumented version of application A featuring self-protection capabilities.

The exemplary algorithm 100 begins in step 110, when application A 105 is instrumented to log its operations, thereby allowing recreation of its execution trace. In step 130, testing is applied to A 105 with security payloads 115. If a vulnerability is detected (125) for any security payload 115, algorithm 100 proceeds to step 140, in which vulnerability is reported to the user, who may be asked to provide a solution. Algorithm 100 then implements this solution and returns (135) to step 130 to rerun the testing for all payloads.

If no vulnerability is detected (145) for any security payload, algorithm 100 proceeds to the next step (150) discussed below. At this point, the security payloads 115 do not demonstrate any vulnerability. However, security payloads 115 may only reflect common attack instances. Thus, it is possible that the application's defenses could still fail to handle uncommon attack instances (e.g., end cases), and thus the defenses may still be only partial and therefore incorrect.

In step 150, for each trace tᵢ corresponding to payload pi (where 1≦i≦n), algorithm 100 determines the point in the trace where the payload value has either been rejected (by a validator) or sanitized (by a sanitizer). This may be done by tracking a malicious value along the trace, checking to see where it has been tested or mutated. The resulting point for each payload denotes a transition across trust boundaries.

In step 170, these candidate points are used to compute and/or infer hypothesized trust boundaries, accounting for the syntactic structure of the application. In step 190, application A is instrumented with built-in defense methods along every possible transition point across the hypothesized trust boundaries, resulting in application A′ as output 195. As previously noted, algorithm 100 produces an output 195 which is A′, an instrumented version of application A featuring self-protection capabilities.

As discussed herein, partial correctness corresponds to the partial defenses implemented by the user which hint toward the user's intention of enforcing trust boundaries, and full correctness is the automatic enforcement of correct defenses along the extracted trust boundaries. One or more illustrative embodiments of the present invention, including algorithm 100, leverage the concept that partial correctness can be lifted to full correctness. Application of this concept in illustrative embodiments advantageously facilitates a revolutionary and powerful approach to application security, which acknowledges the practical setting where this problem is to be solved, whereby developers have limited security knowledge, and find it hard to reason about complex end cases when implementing security defenses.

The aforementioned concept is also applicable to protection of web services in one or more illustrative embodiments of the present invention. Web services often perform only partial checking on incoming data, which leaves open certain attack scenarios which can be exploited in practice by seasoned hackers. One or more illustrative embodiments advantageously facilitate blocking such scenarios, especially where existing web security tools already permit (i) instrumenting web services, and (ii) testing web services with dynamic security payloads, such as with the Generic Service Client (GSC) module of IBM® Security AppScan® Standard.

In the context of computer programming, the terms “instrumenting” or “instrumentation” as used herein refer broadly to the ability of an application to monitor or measure the level of a product's performance, to diagnose errors and/or to output trace information, such as, for example, by monitoring an execution path(s) at prescribed critical points, at least for purposes of debugging and performance evaluation. Generally, programmers implement instrumentation in the form of code instructions (e.g., logging information) that monitor one or more specific components in a system.

Given the discussion thus far, it will be appreciated that, in general terms, an exemplary method for use with an application comprises: testing the application with a set of security payloads to produce a set of execution traces, wherein testing the application with a given one of the set of security payloads produces a corresponding one of the set of execution traces; determining a set of candidate points comprising at least one candidate point for each of the set of security payloads, wherein a candidate point for the given one of the set of security payloads is determined based on the corresponding one of the set of execution traces; inferring a set of trust boundaries based on the determined set of candidate points; computing one or more possible transition points across the inferred set of trust boundaries; and instrumenting the application with a security defense at each of the computed possible transition points across the inferred set of trust boundaries.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

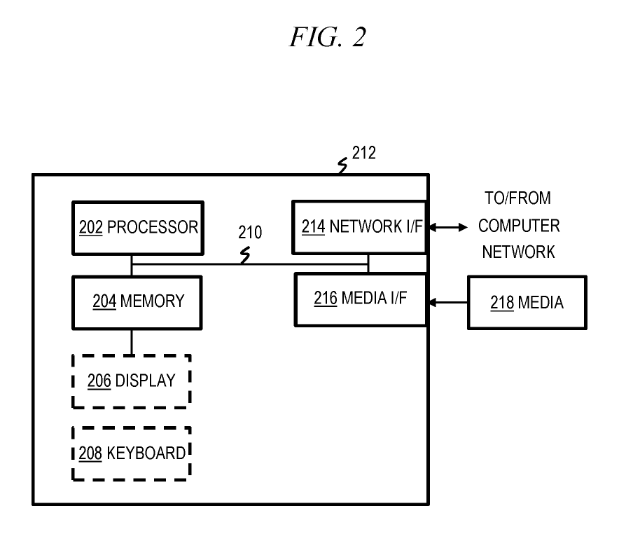

One or more embodiments can make use of software running on a general purpose computer or workstation. With reference to FIG. 2, such an implementation might employ, for example, a processor 202, a memory 204, and an input/output interface formed, for example, by a display 206 and a keyboard 208. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 202, memory 204, and input/output interface such as display 206 and keyboard 208 can be interconnected, for example, via bus 210 as part of a data processing unit 212. Suitable interconnections, for example via bus 210, can also be provided to a network interface 214, such as a network card, which can be provided to interface with a computer network, and to a media interface 216, such as a diskette or CD-ROM drive, which can be provided to interface with media 218.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 202 coupled directly or indirectly to memory elements 204 through a system bus 210. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 208, displays 206, pointing devices, and the like) can be coupled to the system either directly (such as via bus 210) or through intervening I/O controllers (omitted for clarity).

Network adapters such as network interface 214 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 212 as shown in FIG. 2) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a continuous fragmentation cell (component) module, and a decomposition module. The method steps can then be carried out using the distinct software modules and/or sub-modules of the system, as described above, executing on one or more hardware processors 202. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for use with an application, the method comprising:
testing the application with a set of security payloads to produce a set of execution traces, wherein testing the application with a given one of the set of security payloads produces a corresponding one of the set of execution traces;
determining a set of candidate points comprising at least one candidate point for each of the set of security payloads, wherein a candidate point for the given one of the set of security payloads is determined based on the corresponding one of the set of execution traces;
inferring a set of trust boundaries based on the determined set of candidate points;
computing one or more possible transition points across the inferred set of trust boundaries; and
instrumenting the application with a security defense at each of the computed possible transition points across the inferred set of trust boundaries.

2. The method of claim 1, wherein the security defense comprises a runtime check synthesized into the application by a compiler.

3. The method of claim 1, wherein instrumenting the application with a security defense at each of the computed possible transition points across the inferred set of trust boundaries comprises automatically enforcing the security defense on every transition into a trusted area.

4. The method of claim 1, further comprising constraining overhead of the security defense by:
monitoring security-relevant behavior of the application over the set of execution traces; and
tailoring at least one of a scope and a granularity of the security defense based on the monitored behavior.

5. The method of claim 1, wherein a specification is inferred automatically rather than provided by a user, thereby compensating for user error in implementing the security defense.

6. The method of claim 1, wherein testing the application with the set of security payloads to produce the set of execution traces comprises rerunning the testing until no vulnerability is detected for any of the set of security payloads.

7. The method of claim 1, wherein testing the application with the set of security payloads to produce the set of execution traces comprises:
remedying any vulnerability discovered while testing the application with the set of security payloads; and
rerunning the testing until no vulnerability is detected for any of the set of security payloads.

8. The method of claim 1, wherein the set of security payloads represents common attack instances.

9. The method of claim 1, wherein testing the application with the set of security payloads to produce the set of execution traces comprises instrumenting the application to log its operations, thereby allowing recreation of its execution trace.

10. The method of claim 1, wherein determining the set of candidate points comprising at least one candidate point for each of the set of security payloads comprises tracking a value of the given one of the security payloads along the corresponding one of the set of execution traces.

11. The method of claim 10, further wherein determining the set of candidate points comprising at least one candidate point for each of the set of security payloads further comprises adding to the set of candidate points any point at which the value was tested or mutated.

12. The method of claim 10, wherein determining the set of candidate points comprising at least one candidate point for each of the set of security payloads further comprises adding to the set of candidate points any point at which the malicious value was rejected by a validator or sanitized by a sanitizer.

13. The method of claim 10, wherein determining the set of candidate points comprising at least one candidate point for each of the set of security payloads further comprises adding to the set of candidate points any point at which the malicious value was at least of tested, mutated, rejected and sanitized.

14. The method of claim 1, wherein the one or more calculated possible transition points across the inferred set of trust boundaries comprise the determined set of candidate points.

15. The method of claim 1, wherein the application comprises a web application.

16. The method of claim 1, wherein the application comprises one or more web services.

17. An apparatus comprising:
a memory; and
at least one processor coupled to said memory and operative:
to test the application with a set of security payloads to produce a set of execution traces, wherein testing the application with a given one of the set of security payloads produces a corresponding one of the set of execution traces;
to determine a set of candidate points comprising at least one candidate point for each of the set of security payloads, wherein a candidate point for the given one of the set of security payloads is determined based on the corresponding one of the set of execution traces;
to infer a set of trust boundaries based on the determined set of candidate points;
to compute one or more possible transition points across the inferred set of trust boundaries; and
to instrument the application with a security defense at each of the computed possible transition points across the inferred set of trust boundaries.

18. The apparatus of claim 17, wherein the processor is further operative to constrain overhead of the security defense by:
monitoring security-relevant behavior of the application over the set of execution traces; and
tailoring at least one of a scope and a granularity of the security defense based on the monitored behavior.

19. The apparatus of claim 17, wherein determining the set of candidate points comprising at least one candidate point for each of the set of security payloads comprises tracking a value of the given one of the security payloads along the corresponding one of the set of execution traces.

20. A non-transitory computer readable medium comprising computer executable instructions which when executed by a computer cause the computer to perform the method of:
testing the application with a set of security payloads to produce a set of execution traces, wherein testing the application with a given one of the set of security payloads produces a corresponding one of the set of execution traces;
determining a set of candidate points comprising at least one candidate point for each of the set of security payloads, wherein a candidate point for the given one of the set of security payloads is determined based on the corresponding one of the set of execution traces;
inferring a set of trust boundaries based on the determined set of candidate points;
computing one or more possible transition points across the inferred set of trust boundaries; and
instrumenting the application with a security defense at each of the computed possible transition points across the inferred set of trust boundaries.
